(19) United States
(12) Patent Application Publication
(10) Pub. No.: US 2018/0122586 A1
(43) Pub. Date: May 3, 2018

(54) DISPERSION LIQUID FOR FORMATION OF SEMICONDUCTOR ELECTRODE LAYER, AND SEMICONDUCTOR ELECTRODE LAYER

(71) Applicant: MIKUNI SHIKISO KABUSHIKI KAISHA, Himeji-shi (JP)

(72) Inventors: Sumiyo SHIMIZU, Himeji-shi (JP); Taizou HARUYAMA, Himeji-shi (JP)

(73) Assignee: MIKUNI SHIKISO KABUSHIKI KAISHA, Himeji-shi (JP)

(21) Appl. No.: 15/539,174

(22) PCT Filed: Dec. 17, 2015
(86) PCT No.: PCT/JP2015/085331

§ 371 Date: Nov. 20, 2017

(30) Foreign Application Priority Data
Dec. 26, 2014 (JP) 2014-265769

(51) Int. Cl. H01G 9/20; H01G 9/00

(52) U.S. Cl. CPC H01G 9/2027; H01G 9/2031; H01G 9/0029

(57) ABSTRACT

The present invention relates to a slurry for forming a semiconductor electrode layer to obtain a dye-sensitized solar cell containing a porous layer, which is not susceptible to cracking and is capable of providing a higher conversion efficiency. The slurry for forming a semiconductor electrode layer contains two types of metal-oxide semiconductor particles having different particle sizes. When a semiconductor electrode layer is formed by coating and sintering such a slurry, cracking seldom occurs and a higher conversion efficiency is achieved when it is made into a film with a thickness of 3˜20 μm.

### TECHNICAL FIELD

The present invention relates to photoelectric conversion elements such as a dye-sensitized solar cell containing a porous electrode, which is not susceptible to cracking even when it is a thick film of 10˜20 μm.

### BACKGROUND ART

Research and development of renewable energies such as solar cells has become an urgent issue worldwide as concern over global warming and depletion of fossil energy sources is growing. A solar cell is a photoelectric conversion device that converts solar energy into electrical energy. Using sunlight as its energy source, such a device is less likely to tap into finite fossil fuel reserves. Also, its impact on the global environment is significantly minuscule since carbon dioxide emissions caused by fuel combustion are suppressed. So far, various principles and materials have been developed for solar cells, and currently most prevalent are solar cells using silicon semiconductor materials (silicon solar cells). However, for producing silicon solar cells, it is necessary to use high-purity semiconductor materials and to conduct meticulous procedures for the formation of p-n junctions. Accordingly, a greater number of production steps need to be taken in a large-scale production facility. In other words, solar cell production entails problems such as massive energy consumption, high production costs and a heavy environmental load.

Meanwhile, among the studies on solar cells, ever since being proposed by Grätzel et al., dye-sensitized solar cells (see [Non-Patent Literature 1] and [Patent Literature 1]) have been expected to be put into practical use as solar cells that exert less environmental impact, because of advantages such as inexpensive materials and relatively simplified production steps.

### PRIOR ART CITATION LIST

### Non-Patent Literature

Non-patent Literature 1: B. O'Regan and M. Graetzel, Nature, 353, pp. 737-740 (1991)
Non-patent Literature 2: Tsuyoshi OKAI, Hiroshi TSUBAKIHARA, “Highly efficient dye-sensitized solar cells sintered at low temperature,” Research Reports of the School of Engineering, Kinki University, No. 41, 2007, pp. 51-56

### Patent Literature

Patent Literature 1: JP 2664194B
Patent Literature 2: JP 3671183B
Patent Literature 3: JP 4608897B
Patent Literature 4: JP 2011-165469A
Patent Literature 5: JP 2011-210554A
Patent Literature 6: JP 2007-179766A
Patent Literature 7: JP 2013-140701A
Patent Literature 8: JP 2012-59599A

As shown in Patent Literature 1, for example, conventional dye-sensitized solar cells are formed mainly with a transparent substrate such as glass, transparent conductive layer (anode current collector), porous semiconductor electrode layer (anode) holding the photosensitized dye, electrolyte layer, counter electrode (cathode), counter substrate and sealing material.

The transparent conductive layer provided on a transparent substrate is made of ITO (indium tin oxide, indium tin composite oxide), FTO (fluorine-doped tin oxide) and the like, and works as an anode current collector. A semiconductor electrode layer as the anode mostly uses a porous layer formed by sintering fine particles of metal-oxide semiconductors such as titanium oxides, and is provided to be in contact with the transparent conductive layer. The photosensitizing dye is adsorbed on the metal-oxide surfaces of the porous semiconductor electrode layer that is in contact with the transparent conductive layer. As for the electrolyte layer, an electrolyte containing a redox species (redox couple) or the like is used. The counter electrode is made of a platinum layer or the like, and is provided on the counter substrate.

In a dye-sensitized solar cell, light is designed to enter from the transparent substrate (anode current collector) side. Part of the incident light is absorbed by the photosensitizing dye, and some of the electrons excited by the absorbed light flow into the semiconductor electrode layer. After losing electrons, the photosensitized dye is reduced by the reducing species (reducing agent) in the electrolyte layer. The oxidizing species (oxidizing agent) generated in the electrolyte layer through the reduction reaction receives electrons from the counter electrode, and is returned to the reducing species. As a result, the dye-sensitized solar cell works as a photovoltaic cell using the transparent conductive layer and semiconductor electrode layer as the anode and its counter electrode as the cathode.

To produce dye-sensitized solar cells, large-scale facilities for vacuum processing or the like are not necessary; rather, efficient production is achieved by coating with inexpensive semiconductor materials such as titanium oxides. In addition, various photosensitizing dyes are available for absorbing light at their respective wavelengths in a broad wavelength range around the visible light. Thus, high conversion efficiency is achieved at low luminous energy by selecting the type of dye for a wavelength of light to be absorbed or by combining multiple dyes so as to cover a wider wavelength range. Moreover, when lightweight flexible substrates such as plastics are employed for roll-to-roll processing, even higher productivity at lower cost is likely achieved. Accordingly, dye-sensitized solar cells are attracting greater interest these days as the next-generation solar cells.

### SUMMARY OF THE INVENTION

### Problems to be Solved by the Invention

In a dye-sensitized solar cell, a metal-oxide semiconductor electrode layer carries out functions such as dye adsorption, electron transfer from the excited dye, flow of electric charge in the electrolyte, confinement of light and scattering of light, all of which significantly affect the efficiency of photoelectric conversion. To effectively carry out such functions, a semiconductor electrode layer is necessary to have a greater surface area, to be porous, to be an electrically continuous layer, and to have continuous pores.

Patent Literatures 2 and 3 propose use of a metal alkoxide to increase the surface area and achieve the necking effect. The method employs hydrolysis reactions of metal alkoxide, which is easily decomposed by a trace of moisture in air and is unstable. The metal oxide obtained through reactions is in an amorphous state; if the amount is small, adhesiveness is insufficient among metal-oxide semiconductor fine particles and between metal-oxide semiconductor fine particles and the conductive substrate, and the metal-oxide fine particles tend to peel off. By contrast, a greater amount causes surfaces of metal-oxide fine particles to be coated with the amorphous metal oxide, thus masking the film. Accordingly, the initial purpose of achieving porous properties is blocked, and the performance as the electrode is lowered.

Patent Literatures 4, 5 and 6 propose methods that use a mixture of two types of metal-oxide semiconductor fine particles. In Patent Literature 4, using a mixture of two types of dispersion liquids containing metal-oxide semiconductor fine particles suppresses cracking, but their particle sizes cause masking and thus lower the effects of the electrode. Patent Literature 5 proposes coating and sintering two types of porous layers one layer at a time. In such a method, the film is expected to be less likely to crack due to the necking effect, but producing the electrode film is thought to take a longer time.

In Patent Literature 6, a dispersion liquid containing two types of titanium oxide is used for forming electrodes and dye-sensitized solar cells. As the two types of titanium oxide, particles (A) are those obtained when primary particles having a particle size of 10˜15 nm are bonded to form secondary particles having a particle size of 100˜2000 nm; and the other particles (B) are those having a primary particle size of 2˜15 nm, which are designed to enter the gaps of particles (A). Particles (A) are obtained when a basic titanium salt is added to a water-soluble alkali to precipitate a titanium hydroxide, which is further mixed with a water-soluble acid to produce an aqueous sol of titanium oxide.

However, since the above method is for forming fine particles through precipitation and pulverization procedures, the particles are thought to be less uniform. Moreover, particles (A) are formed when primary particles are bonded to form secondary particles having a larger particle size of 100˜2000 nm. Thus, particles (A) are unstable, and using the particles as is may cause sedimentation and result in an uneven mixture. For that matter, electric repulsion force of the particles is thought to be employed in the method to stabilize the particles. However, a uniform stable slurry is thought to be difficult to obtain by such a method. In addition, the composition is vacuum-condensed, and ethylene glycol or the like is added to it so that the viscosity of the composition is increased to make a coatable slurry. Such a series of procedures is significantly complex and not suitable for achieving constantly stable physical properties.

Non-patent Literature 2 also proposes to use two types of titanium oxide fine particles. The particle sizes are assumed to be those of primary particles, which are thought to cause the same problems as in Patent Literature 6 if they are formed by the same method. In addition, neither the method for mixing two types of particles nor the characteristics of the mixture are stated. Furthermore, the conversion efficiency of the obtained cell is approximately 4%, which is not sufficient.

### Solutions to the Problems

Accordingly, the inventors of the present invention have conducted intensive study to solve the aforementioned problems. In addition to using two specific types of metal-oxide semiconductor fine particles having different particle sizes, the inventors focused on controlling the dispersion state of particles in the slurry. As a result, the inventors have found that a certain dispersion state of particles in a slurry significantly contributes to the cell performance; particles are preferred to be dispersed in the presence of a polymer dispersant; and in a film formed by coating and sintering the slurry, cracking seldom occurs and high conversion efficiency is achieved even when it is a thick film of 10˜20 μm, while high conversion efficiency is also achieved when it is a thin film of 3˜10 μm.

Namely, the present invention has the following aspects:

(1) A slurry for forming a semiconductor electrode layer, containing at least two types of metal-oxide semiconductor fine particles having different primary particle sizes that are dispersed in a liquid medium, in which one type of the fine particles has a modal primary particle size of 1˜50 nm, while the other type has a modal primary particle size of 1˜13 nm, and the dispersed particle size of the metal-oxide semiconductor fine particles in a liquid is 1˜200 nm.
(2) A slurry for forming a semiconductor electrode layer, containing at least two types of metal-oxide semiconductor fine particles having different primary particle sizes that are dispersed in a liquid medium, in which one type of the fine particles has a modal primary particle size of 1˜50 nm, while the other type has a modal primary particle size of 1˜13 nm, and a polymer dispersant is contained in the slurry.
(3) The slurry for forming a semiconductor electrode layer according to (2), in which the polymer dispersant is at least one type selected from among acrylic copolymers, butyral resins, vinyl acetate copolymers, hydroxyl group-containing carboxylic acid esters, salts of high molecular weight polycarboxylic acids, alkyl polyamines, and polyhydric alcohol esters.
(4) The slurry for forming a semiconductor electrode layer according to any of (1)˜(3), in which the metal-oxide semiconductor fine particles are particles of at least one type selected from among titanium oxides, tin oxides, niobium oxides, tungsten oxides, and strontium titanates.
(5) The slurry for forming a semiconductor electrode layer according to any of (1)˜(4), in which the weight ratio is set at 100/1˜23 when combining a type of metal-oxide semiconductor fine particles having a modal particle size of 1˜50 nm and another type having a modal particle size of 1˜13 nm.
(6) A method for forming a semiconductor electrode layer, characterized by coating a substrate with the slurry for forming a semiconductor electrode layer according to any of (1)˜(5) and by sintering the coated slurry.
(7) A semiconductor electrode layer, formed by coating a substrate with the slurry for forming a semiconductor electrode layer according to any of (1)˜(5) and by sintering the coated slurry.
(8) The semiconductor electrode layer according to (7), in which the metal-oxide semiconductor fine particles are particles of at least one type selected from among titanium oxides, tin oxides, niobium oxides, tungsten oxides, and strontium titanates.
(9) The semiconductor electrode layer according to (7) or (8), in which the ratio is set at 100/1˜23 parts by weight when combining a type of metal-oxide semiconductor fine particles having a modal particle size of 1˜50 nm and another type having a modal particle size of 1˜13 nm.
(10) A semiconductor electrode layer, containing at least two types of metal-oxide semiconductor fine particles having different primary particle sizes, in which the film thickness is set at 3 μm˜20 μm, virtually no cracking is present, and the conversion efficiency is 8.0 or higher.
(11) A solar cell, containing as its electrode the semiconductor electrode layer according to any of (7)˜(10).

In the present application, metal-oxide semiconductor fine particles being “dispersed in a liquid medium” means that the particles are present in a dispersed state in a liquid medium; namely, particles are in a slurry state.

### Effects of the Invention

A slurry related to the present invention exhibits excellent properties for forming a metal-oxide semiconductor electrode layer to be used in a dye-sensitized solar cell; even when the coated film is a thick film of 10˜20 μm, cracking seldom occurs and high conversion efficiency is achieved, while high conversion efficiency is also achieved when the coated film is a thin film of 3˜10 μm.

### BRIEF DESCRIPTION OF THE DRAWINGS

FIG. 1 is a view showing an example of a solar cell that contains an electrode layer related to the present invention;

FIG. 2 is an image taken at 500× magnification showing the electrode obtained in Example 1;

FIG. 3 is an image taken at 500× magnification showing the electrode obtained in Example 2;

FIG. 4 is an image taken at 500× magnification showing the electrode obtained in Example 3;

FIG. 5 is an image taken at 500× magnification showing the electrode obtained in Example 4;

FIG. 6 is an image taken at 500× magnification showing the electrode obtained in Example 5;

FIG. 7 is an image taken at 500× magnification showing the electrode obtained in Example 6;

FIG. 8 is an image taken at 500× magnification showing the electrode obtained in Example 7;

FIG. 9 is an image taken at 500× magnification showing the electrode obtained in Comparative Example 1;

FIG. 10 is an image taken at 500× magnification showing the electrode obtained in Comparative Example 2;

FIG. 11 is an image taken at 500× magnification showing the electrode obtained in Comparative Example 3;

FIG. 12 is an image taken at 500× magnification showing the electrode obtained in Comparative Example 4;

FIG. 13 is an image taken at 500× magnification showing the electrode obtained in Comparative Example 5;

FIG. 14 is an image taken at 500× magnification showing the electrode obtained in Comparative Example 6;

FIG. 15 is an image taken at 500× magnification showing the electrode obtained in Comparative Example 7; and

FIG. 16 is a graph showing the relationship between film thicknesses of the electrodes obtained in Examples 10˜18 and their respective conversion efficiencies.

### DETAILED DESCRIPTION OF THE EMBODIMENTS

(Materials)

The slurry for forming a semiconductor electrode layer related to the present invention contains at least two types of metal-oxide semiconductor fine particles having different primary particle sizes that are present in a dispersion medium. If applicable, the slurry may further contain a dispersant capable of finely dispersing the metal-oxide semiconductor particles in a dispersion medium, a binder resin, materials to be contained in a solar cell electrode, or components to be contained in electrode forming paste.

1. Metal Oxide Particles

Among the components, two or more types of particles having different primary particle sizes are used as the metal-oxide semiconductor particles related to the present invention. Here, particles “having different primary particle sizes” mean an agglomerate of particles having different modal particle sizes (mode). In other words, “two or more types of particles having different primary particle sizes” means having two or more clear peaks in the particle-size distribution.

Regarding primary particle sizes of two types of metal-oxide semiconductor fine particles, the primary particle size of larger particles is 1˜50 nm, preferably 1˜40 nm, whereas the primary particle size of smaller particles is 1˜13 nm, preferably 1˜12 nm.

In addition, regarding particle distributions, at least 80 wt. %, preferably at least 90 wt. %, of larger particles is preferred to have a primary particle size of 1˜60 nm, preferably 1˜45 nm; and at least 80 wt. %, preferably at least 90 wt. %, of smaller particles is preferred to have a primary particle size of 1˜20 nm, preferably 1˜15 nm. As for the particle distribution of the entire particle, at least 80 wt. %, preferably at least 90 wt. %, is preferred to have a primary particle size of 1˜60 nm, preferably 1˜45 nm. Setting such ranges is preferable for achieving excellent performance, since no extremely large particle size is included and a sharp distribution curve is obtained.

To measure primary particle sizes of metal-oxide semiconductor fine particles, a trace of metal-oxide semiconductor fine particles in powder was set and photographed at a magnification of 100,000 times using an ultra-high resolution field emission scanning electron microscope (S-5200), made by Hitachi High-Technologies Corporation. The image was analyzed by an SEM imaging platform, Scandium, made by Olympus Soft Imaging Solutions. Using venire calipers, 200 particles in the image were measured and a particle distribution graph was prepared. The modal value was obtained from the particle distribution graph. Any other method may be employed as long as it is capable of measuring particle sizes.

As for primary particle sizes of two types of metal-oxide semiconductor fine particles, the primary particle size of larger particles is 1˜50 nm, preferably 1˜40 nm, whereas the primary particle size of smaller particles is 1˜13 nm, preferably 1˜12 nm. Those metal-oxide semiconductor fine particles are dispersed in an organic solvent containing a polymer dispersant.

The composition ratio of fine particles having the largest particle size to those having the second largest particle size is set to be larger particles/smaller particles=100/1˜23 parts by weight, preferably 100/2˜20 parts by weight. Two or more types of particles in metal-oxide semiconductor fine particles may be dispersed individually in a dispersion medium, or may be dispersed simultaneously in a dispersion medium.

It is an option to include even larger particles, smaller particles or medium-size particles in addition to the above defined larger and smaller particles. However, it is necessary to limit the amount in a range that will not affect the effects of the present invention. The amount of particles other than the above-defined larger and smaller particles is preferred to be 10 wt. % or less, more preferably 5 wt. % or less, of the entire amount of metal-oxide semiconductor fine particles.

For metal-oxide semiconductor fine particles, titanium oxides, tin oxides, niobium oxides, zinc oxides, tungsten oxides or strontium titanates are preferred to be used. Among them, titanium oxides and zinc oxides are preferred in view of their relatively abundant resources, lower costs and a wider band gap; and titanium oxides are especially preferable considering the ease of controlling accuracy in porous structures.

Anatase-phase, rutile-phase and their mixed-phase titanium oxides are available. In the embodiments of the present invention, any type may be used. Also, any known method may be employed for forming titanium oxides. Among commercially available products, those having larger particles are “P25” (product name, made by Nippon Aerosil Co., Ltd., anatase/rutile=80/20, primary particle size: 21 nm), “F4” (product name, made by Showa Denko K.K., rutile content of 20% or less, primary particle size: 30 nm), “AMT600” (product name, made by TAYCA CORPORATION, anatase content of 100%, primary particle size: 30 nm), and the like. As for products having smaller particles, “AMT100” (product name, made by TAYCA, anatase content of 100%, primary particle size: 6 nm) and the like are available.

2. Dispersant

Dispersants are substances capable of finely dispersing metal-oxide semiconductor fine particles in a dispersion medium. Among various types of dispersants known for dispersing solid fine particles in liquid media, any type may be used in the embodiments of the present invention. Especially preferred are polymer dispersants, for example, acrylic copolymers, butyral resins, vinyl acetate copolymers, hydroxyl group-containing carboxylic acid esters, salts of high molecular weight polycarboxylic acids, alkyl polyamines, and polyhydric alcohol esters.

3. Dispersion Medium

Organic solvents are usually used as dispersion media. However, solvents to be used are not limited particularly. Examples are alcohol solvents such as ethanol, isopropyl alcohol, benzyl alcohol and terpineol; glycol-based solvents such as glycerin, ethylene glycol and propylene glycol; halogenated solvents such as chloroform and chlorobenzene; nitrile solvents such as acetonitrile and propionitrile; ketone solvents such as acetone, methyl ethyl ketone and cyclohexanone; ester solvents such as ethyl acetate and butyl acetate: hydrocarbons such as hexane, mineral spirits, toluene and xylene; amines such as dimethylformamide and n-methylpyrrolidone; and the like. Those listed above are not the only options, and they may be used in combination thereof.

4. Binder Resin

Binder resins are preferred to be resin celluloses such as ethyl cellulose, carboxymethyl cellulose, methyl cellulose and hydroxyethyl cellulose. However, material of polymer binders is not limited to the above; various thermoplastic resins, thermosetting resins, and mixtures thereof may also be used. Examples of thermoplastic resins are polyethylene, polypropylene, polystyrene, polyvinylidene fluoride, methacrylic resins, polyether imide, polyether ether ketone, polytetrafluoroethylene, and the like. Examples of thermosetting resins are phenol resins, urea resins, melamine resins, urethane resins, silicone resins and the like. Those listed above may be used alone or in combination thereof. They may be noncrystalline or crystalline resins.

[Content of Each Component]

In an electrode layer containing metal-oxide semiconductor fine particles, factors believed to significantly affect the performance of solar cells are the surface area of semiconductor fine particles, structure of pores formed among particles, structure of continuously connected particles, size and distribution of pores, and the like. Therefore, in the slurry, it is thought to be important to set the concentration of metal-oxide semiconductor fine particles and the concentration of organic binder resin that disappears during sintering and forms pores.

The concentration of metal-oxide semiconductor fine particles in a slurry is preferred to be 5˜50 wt. %, more preferably 10˜45 wt. %, even more preferably 12˜35 wt. %. When the concentration of metal-oxide semiconductor fine particles is lower than the above lower limit, adhesion among those fine particles in a film or adhesion of those fine particles to the substrate may be insufficient to efficiently transfer electrons. On the other hand, when the concentration of metal-oxide semiconductor fine particles exceeds 50 wt. %, the porous structure formed after sintering may become discontinuous or too small for redox reactions to be sufficiently carried out. Regarding metal-oxide semiconductor fine particles in a slurry, a content of 12˜35 wt. % makes it easier to adjust the entire slurry concentration and to obtain a porous electrode layer having an appropriate film thickness.

The concentration of an organic binder resin in a slurry is preferred to be 1˜60 wt. %, more preferably 1.5˜50 wt. %, even more preferably 2˜40 wt. %. When the concentration of organic binder resin is lower than the above lower limit, it may be difficult to obtain a porous structure in an electrode layer. On the other hand, a concentration exceeding the above upper limit may increase the rate of pores formed after sintering in the layer, and the film strength is thereby lowered. Also, adhesion among metal-oxide semiconductor fine particles may not be enough to efficiently transfer electrons.

[Preparation Method]

1. Preparing Dispersion Liquid of Metal-Oxide Semiconductor Fine Particles

It is preferred to prepare in advance a dispersion liquid by adding a dispersion medium and a polymer dispersant to metal-oxide semiconductor fine particles.

As for a solvent, using the dispersion medium described above as a component of the slurry is preferable since solvent shock is preventable and no extra step for removing solvent is necessary.

Polymer dispersants are not limited particularly, and examples are acrylic copolymers, butyral resins, vinyl acetate copolymers, hydroxyl group-containing carboxylic acid esters, salts of high molecular weight polycarboxylic acids, alkyl polyamines, and polyhydric alcohol esters. When particles are dispersed in the presence of a polymer dispersant, it is easier to maintain a preferred state of dispersion as described later. When a slurry contains metal-oxide semiconductor fine particles dispersed in a preferable state and is coated on a substrate, the obtained electrode exhibits excellent performance as described later.

As for the dispersion state of metal-oxide semiconductor fine particles, it is preferred to have a dispersed particle size in a range specified below. A dispersed particle size means the particle size of metal-oxide semiconductor fine particles when they are present in a dispersion medium; and the size is measured by diluting the dispersion liquid with the medium used for dispersing the particles to have a solid particle concentration of 300 ppm using a particle size analyzer Nanotrak UPA-EX, made by Nikkiso Co., Ltd., through dynamic light scattering measurement. More specifically, when the concentration of dispersed metal-oxide semiconductor fine particles is 30 wt. %, 0.05 grams of the dispersion liquid is accurately weighed and diluted with the dispersion medium to make a precise weight of 50.00 grams. Then, the diluted dispersion liquid is stirred for an hour to form a sample. From the particle size distribution curve, the particle size (nm) as the value at 50% in the cumulative distribution is determined to be the median dispersed particle size. Any other method may be used as long as the dispersed particle size is obtained.

When the dispersed particle size is closer to the modal primary-particle size of the metal-oxide semiconductor fine particles, the dispersion is determined to be well progressed. The dispersed particle size of metal-oxide semiconductor fine particles having a larger particle size is preferred to be in a range of 20˜200 nm, more preferably 20˜150 nm, even more preferably 20˜100 nm. The dispersed particle size of metal-oxide semiconductor fine particles having a smaller particle size is preferred to be in a range of 1˜60 nm, more preferably 1˜50 nm, even more preferably 1˜30 nm.

It is preferred to disperse particles to have a predetermined particle distribution by separately dispersing larger particles and smaller particles, but it is also an option to simultaneously disperse the mixture of larger and smaller particles. In such a case, the preferred particle size distribution of the entire mixture is 1˜200 nm, more preferably 1˜150 nm, even more preferably 1˜100 nm.

In addition, in the particle size distribution obtained as above, the particle size of larger particles at 90% in the cumulative distribution is preferred to be 10˜250 nm, more preferably 10˜200 nm, even more preferably 10˜150 nm, whereas that of smaller particles is preferred to be 1˜80 nm, more preferably 1˜60 nm, even more preferably 1˜50 nm. As for the particle size of the entire dispersion, it is preferred to be 1˜250 nm, more preferably 1˜200 nm, even more preferably 1˜150 nm. In such ranges, since the amount of coarse particles is limited, the slurry is thought to have especially excellent properties.

The dispersion equipment is not limited particularly, for example, a media disperser or collision disperser may be used. In a disperser using media, small media such as glass, alumina, zirconia, steel and tungsten are moved at high speed in a bessel so that the slurry passing through the media are ground by shear force. Examples of such equipment are ball mills, sand mills, pearl mills, agitator bead mills, CoBall-Mills, Ultra Visco Mills, ultrafine grinding mills and the like. Dispersers using collision force are those that pulverize pigments or the like in fluids by making a fluid collide at high speed against a wall surface or causing a collision at high speed between fluids. Examples are Nano-Mizers, homogenizers, microfluiders, multimizers and the like.

2. Preparing Binder Resin Solution

A binder resin in powder is preferred to be prepared as a resin solution by mixing a solvent in advance, if applicable, and by stirring and dissolving the powder. Adding a binder resin brings the viscosity of the slurry to a level suitable for coating.

Especially preferable resin components are resin celluloses such as ethyl cellulose, carboxymethyl cellulose, methyl cellulose and hydroxyethyl cellulose. However, material of polymer binders is not limited to the above; various thermoplastic resins, thermosetting resins, and mixtures thereof may also be used. Examples of thermoplastic resins are polyethylene, polypropylene, polystyrene, polyvinylidene fluoride, methacrylic resins, polyether imide, polyether ether ketone, polytetrafluoroethylene, and the like. Examples of thermosetting resins are phenol resins, urea resins, melamine resins, urethane resins, silicone resins and the like. Those listed above may be used alone or in combination thereof. They may be non-crystalline or crystalline resins.

The solvent to dissolve a binder resin is not limited particularly, but it is preferred to use the same dispersion medium as described above so as to prevent the risk of agglomeration or the like of the dispersed particles caused by solvent shock.

When a dispersion liquid of metal-oxide semiconductor fine particles, a binder resin solution and a solvent are prepared in advance by the above-described methods and combined, it is easier to form a slurry having excellent physical properties.

[Forming Electrode Layer]

A semiconductor electrode layer is obtained when the above-prepared slurry is coated on a conductive substrate, which is then sintered in an electric oven. The prepared electrode layer is used as a photoelectric conversion element. As for the conductive substrate for that purpose, it is not limited particularly, and any known substrate materials may be used; examples are FTO-coated glass, ITO-coated glass, metal substrates, substrates obtained by forming a metal film on a transparent substrate, and the like.

To coat a slurry, for example, dipping, spray coating, wire-bar coating, spin coating, roller coating, blade coating, gravure coating, offset or screen printing or the like may be used; however, any other method may also be employed.

The electrode layer related to the present invention prepared as above is highly transparent, is capable of suppressing cracking and exhibits high photoelectric conversion efficiency even when it is a thick film of 10˜20 μm. The mechanism for such functioning of the electrode layer is not completely evident, but it is assumed as follows: since the metal-oxide semiconductor fine particles related to the present invention are an agglomeration of fine particles of a few nanometers to scores of nanometers, light transmission properties are well maintained to allow light to be transmitted deep into the film, thus contributing to efficient charge separation for easier electron transfer; densely aligned larger and smaller fine particles suppress cracking caused by thermal contraction during sintering; and fine particles enlarge the surface area of the electrode layer, thereby increasing the dye-adsorption amount, while maintaining porous properties and preventing a decrease in the charge transfer.

Moreover, even when it is formed into a thin film of 3˜10 μm, the electrode layer related to the present invention is highly transparent, is capable of suppressing cracking and exhibits high photoelectric conversion efficiency. Moreover, since adhesiveness with the substrate is excellent, mechanical strength is maintained so as to prevent film peeling or the like. The reason for such functioning is not completely evident, but it is assumed that the aforementioned mechanism contributes to achieving a higher efficiency. In addition, it is also assumed that two or more types of well-aligned semiconductor fine particles enhance the necking effect of fine particles, and thus excellent adhesion is obtained among metal-oxide semiconductor fine particles and between fine particles and the substrate. Accordingly, it is thought that mechanical strength is maintained and film peeling or the like is unlikely to occur.

In other words, it is assumed that metal-oxide semiconductor fine particles having a modal particle size of 1˜50 nm work as an essential factor to control the film structure, while particles having a modal particle size of 1˜13 nm enter the gaps among larger particles and adhere particles together or adhere the substrate and particles so as to function as a bridging factor. Accordingly, the flow of electrons is facilitated while increasing film strength.

As described, by coating a substrate with the slurry related to the present invention, the obtained semiconductor electrode layer contains at least two types of metal-oxide semiconductor fine particles having different primary particle sizes, and is characterized in that a film thickness is 3˜20 μm, substantially no cracking occurs, and conversion efficiency is 8.0 or higher. Here, substantially no cracking means when the electrode layer is observed at a magnification of 500 times by using a Keyence VHX-500F digital microscope or an instrument with equivalent or higher capability, the number of cracks with a recognizable length of 100 μm or longer in the viewfield is five or fewer, preferably 3 or fewer, most preferably none.

[Forming Solar Cell]

Using the electrode layer described above, a solar cell is prepared by a known method. The structure of the cell is not limited particularly, and structures shown in various known publications such as Patent Literatures 1, 7 and 8 may be employed.

(1) Structure of Photoelectric Conversion Element

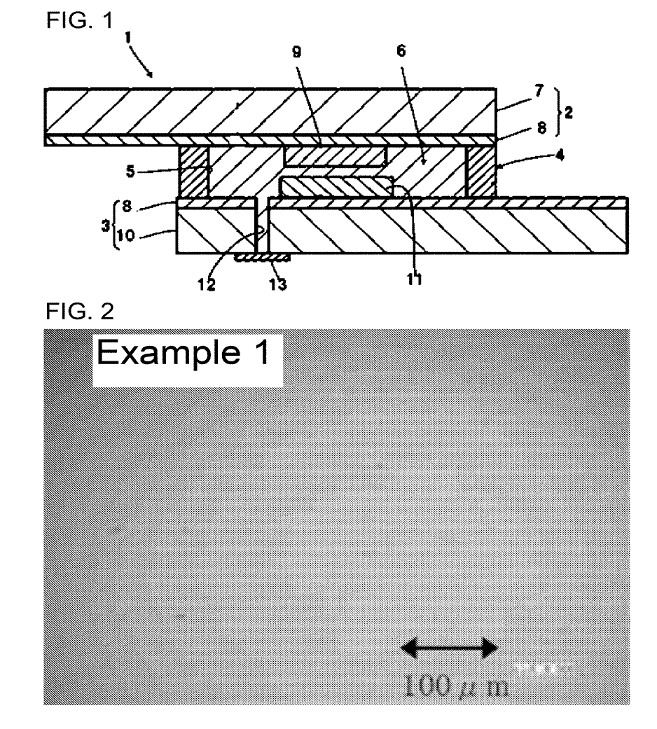

FIG. 1 shows an example of a photoelectric conversion element formed using the electrode layer related to the present invention.

Photoelectric conversion element (solar cell) 1 is formed with action electrode 2, counter electrode 3, sealing layer 4 to connect and seal those electrodes, sealed space 5 formed with those electrodes and the inner-wall surfaces of the sealing layer, and electrolyte layer 6 filled in sealed space 5.

Action electrode 2 is formed with plate-shaped light-transmissible substrate 7 made of light transmissible materials such as glass and ceramics, and transparent electrode member 8 made of ITO (indium tin oxide), FTO (fluorine-doped tin oxide) or the like. On transparent electrode member 8, dye-sensitized semiconductor layer 9 is fixed on one side, and sealing layer 4 is fixed in a position to locate dye-sensitized semiconductor layer 9 inside sealed space 5.

Dye-sensitized semiconductor layer 9 is formed by coating the slurry related to the present invention, on which a sensitizing dye such as azo dyes and ruthenium-bipyridine metal complex dyes is further adsorbed. When light such as sunlight is absorbed by sensitizing dyes, they are excited and emit electrons, which are injected into the oxide semiconductors.

Counter electrode 3 is formed with counter substrate 10 made of hard members such as glass, metals and ceramics, and conductive catalytic electrode layer 11 is coated as a film on one surface of the counter substrate.

On catalytic electrode layer 11, sealing layer 4 is fixed so that it faces dye-sensitized semiconductor layer 9 with sealed space disposed between them.

Penetrating hole 12 is formed through counter substrates (8, 10) and catalytic electrode layer 11 at a predetermined spot, through which an electrolyte composition is injected. To prepare an electrode, action electrode 2 and counter electrode 3 are fixed with a sealing material, and then an electrolyte composition is injected through penetrating hole 12 to fill in sealed space 5. Then, penetrating hole 12 is plugged with sealing material 113 so as to tight-seal the space. Accordingly, electrolyte layer 6 made of an electrolyte composition is formed in sealed space 5.

### EXAMPLES

In the following, the present invention is described in detail by referring to the examples. However, the present invention is not limited to those examples.

### Examples 1˜7, Comparative Examples 1˜8

### [Preparing Slurry]

Titanium-oxide fine particles were used as metal-oxide semiconductor fine particles. The materials listed in Table 1 were mixed at ratios shown in Table 2, and dispersion liquids were prepared by the following method.

Titanium-oxide dispersion liquids 1˜8 were prepared by mixing materials for 7 hours using a paint shaker (made by Asada Iron Works Co., Ltd.) and alumina beads having a diameter of 0.1 mm.

The viscosity and median dispersed particle size of each dispersion liquid are shown in Table 2.

An organic binder is mixed and dissolved in terpineol to prepare an organic binder solution with a solid content of 15 wt. %.

TABLE 1

| | |
|---|---|
| Titanium | P25 (anatase/rutile = 80/20, primary particle size: 21 nm, |
| oxide A | made by Nippon Aerosil) * |
| Titanium | F4 (rutile 20% or less, primary particle size: 30 nm, made |
| oxide B | by Showa Denko) * |
| Titanium | AMT600 (anatase 100%, primary particle size: 30 nm, |
| oxide C | made by Tayca) * |
| Titanium | JA-1 (anatase 100%, primary particle size: 180 nm, made |
| oxide D | by Tayca) |
| Titanium | P90 (anatase/rutile = 80/20, primary particle size: 14 nm, |
| oxide E | made by Nippon Aerosil) |
| Titanium | F6 (rutile 10% or less, primary particle size: 15 nm, made |
| oxide F | by Showa Denko) |
| Titanium | TPK102 (anatase 100%, primary particle size: 15 nm, made |
| oxide G | by Tayca) |
| Titanium | AMT100 (anatase 100%, primary particle size: 6 nm, made |
| oxide H | by Tayca) ** |
| Polymer | (phosphate ester) copolymer having an acid group |
| dispersant a | |
| Polymer | polyether amine |
| dispersant b | |
| Polymer | acrylic copolymer |
| dispersant c | |
| Organic | Ethocel 45, made by Nisshin Kasei |
| binder | |

* Titanium oxides A, B and C: at least 90 wt. % of particles has a primary particle size of 1~45 nm.
** Titanium oxide H: at least 90 wt. % of particles has a primary particle size of 1~15 nm.

TABLE 2

| | Type of Dispersion | | | | | | | |
|---|---|---|---|---|---|---|---|---|
| | Dispersion | Dispersion | Dispersion | Dispersion | Dispersion | Dispersion | Dispersion | Dispersion |
| | liquid 1 | liquid 2 | liquid 3 | liquid 4 | liquid 5 | liquid 6 | liquid 7 | liquid 8 |
| Type of titanium oxide | A | B | C | D | E | F | G | H |
| Amount of titanium oxide | 30 | 30 | 30 | 30 | 30 | 30 | 30 | 30 |
| Type of dispersant | a | a | a | a | a | a | a | a |
| Amount of dispersant | 2 | 2 | 2 | 2 | 5 | 5 | 5 | 10 |
| Dispersion medium | 68 | 68 | 68 | 68 | 65 | 65 | 65 | 60 |
| Dispersion liquid: viscosity (mPa/s) | 74 | 72 | 62 | 59 | 91 | 84 | 64 | 99 |
| Dispersion liquid: particle size (nm) | 38 | 34 | 32 | 189 | 25 | 28 | 20 | 12 |

Type of Dispersion

| | Dispersion | Dispersion | Dispersion | Dispersion |
|---|---|---|---|---|
| | liquid 9 | liquid 10 | liquid 11 | liquid 12 |
| Type of titanium oxide | A | A | H | H |
| Amount of titanium oxide | 30 | 30 | 30 | 30 |
| Type of dispersant | b | c | b | c |
| Amount of dispersant | 2 | 2 | 10 | 10 |
| Dispersion medium | 68 | 68 | 68 | 68 |
| Dispersion liquid: viscosity (mPa/s) | 72 | 89 | 69 | 78 |
| Dispersion liquid: particle size (nm) | 42 | 37 | 11 | 20 |

* In dispersion liquids 1, 2, 3, 9 and 10, the titanium-oxide particle sizes at 90% in the cumulative distribution are each in a range of 10~150 nm. In dispersion liquids 8, 11 and 12, the titanium-oxide particle sizes at 90% in the cumulative distribution are each in a range of 1~50 nm.

Next, slurries 1˜15 were prepared by mixing dispersion liquids and solutions at their respective ratios shown in Table 3. Elements were obtained using slurries 1˜15 by the method below.

[Preparing Dye-Sensitized Photoelectric Element]

An Asahi Glass FTO transparent conductive glass substrate (sheet resistance: 13 Ω/□, 15 mm×25 mm×1.8 mm) was cut to size, then cleaned by UV treatment.

On the FTO substrates, slurries 1˜15 prepared above were respectively coated by a screen printer (200 mesh).

Slurry layers were laminated by repeating the coating process on a substrate, and the substrate with laminated slurry layers was sintered in an electric oven (FT-101FM, made by FLUTECH CO., LTD.) heated at 500° C. for 30 minutes until the thickness of the sintered coated layer was 15 μm, and then left standing to cool.

Next, the substrate was immersed in a 0.5 mM N719 (ruthenium-complex dye, made by Sigma-Aldrich) at 40° C. for 20 hours, washed with acetonitrile, and dried. Accordingly, a porous photoelectrode with a photosensitizing dye supported thereon was obtained.

As for the counter electrode, an FTO/glass counter electrode was used, prepared by sputtering platinum fine particles on an Asahi Glass FTO transparent conductive glass substrate.

In acetonitrile, 0.025 M iodine, 0.1 M lithium iodide, 0.5 M t-butylpyridine, and 0.6 M 1,2-dimethyl-3-propylimidazolium iodide were dissolved to obtain an electrolyte.

In addition to the above prepared porous electrode, counter electrode and electrolyte, an ionomer resin, Himilan®, made by Du Pont-Mitsui Polychemicals Co. Ltd., was used as a sealing agent to form a layer that seals the semiconductor electrode and counter electrode. Accordingly, a solar cell shown in FIG. 1 was formed and its conversion efficiency was measured.

[Evaluation of Film Characteristics of Porous Photoelectrode and Cell Performance]

Measurement and evaluation were conducted as follows.

### 1. Measurement of Film Thickness

Compact surface texture measuring instrument: “SURFCOM 130A” made by Accretech-Tokyo Seimitsu Co., Ltd.

### 2. Evaluation of Dye-Sensitized Solar Cell

By irradiating pseudo-sunlight (1 sun: AM 1.5, 100 mW/cm²), short-circuit current density (Jsc), open-circuit voltage (Voc), fill factor (FF) and photoelectric conversion efficiency (η) were measured (25° C.).

### 3. Evaluation of Film Properties

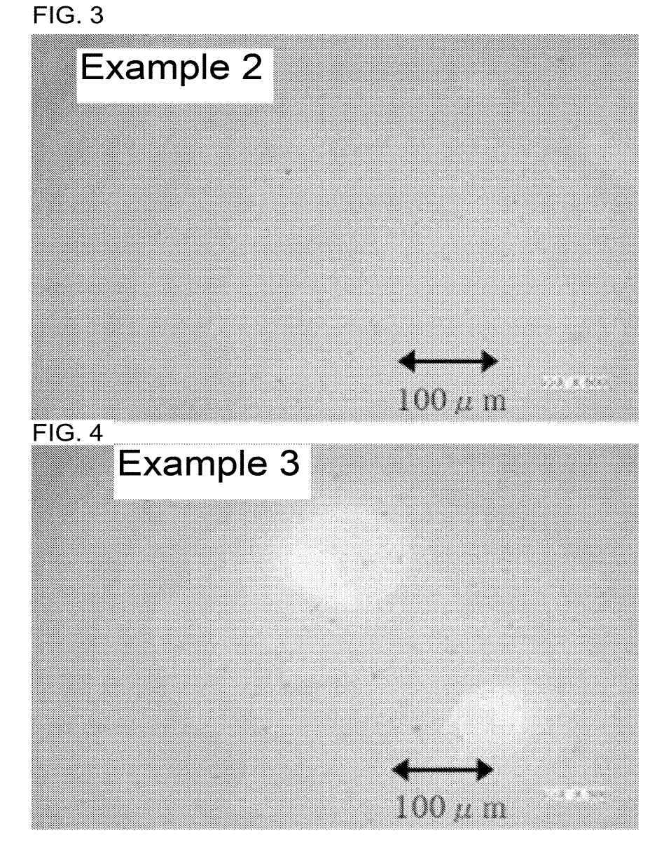

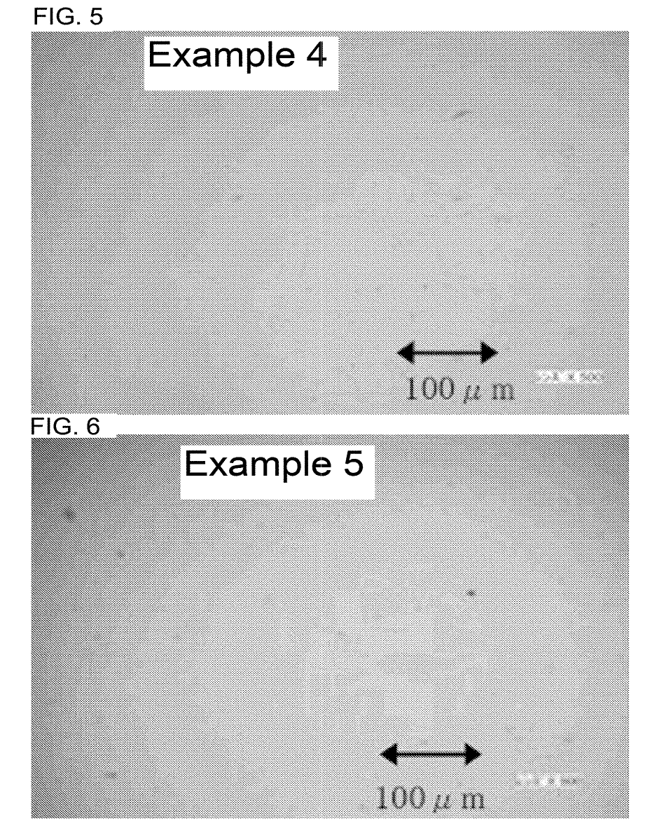

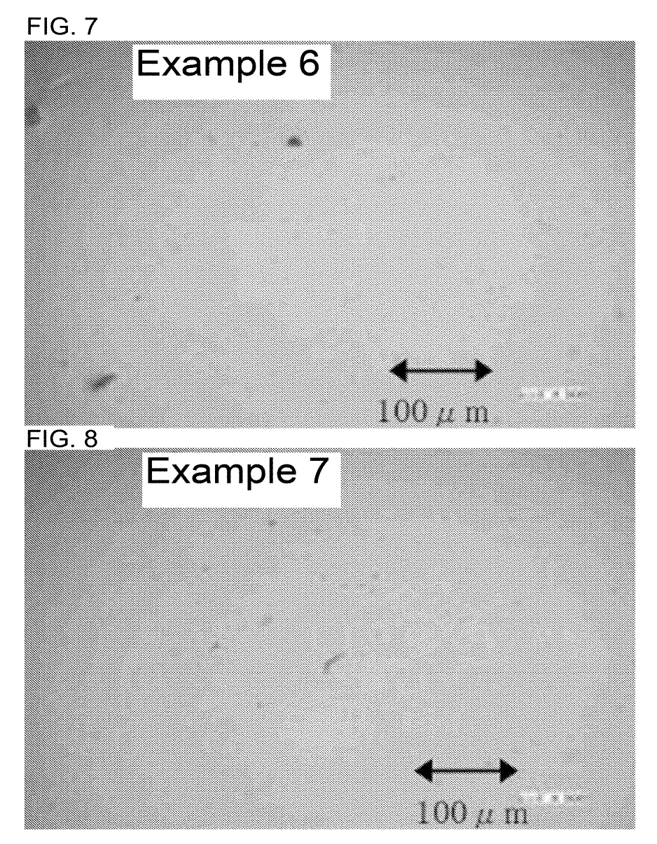

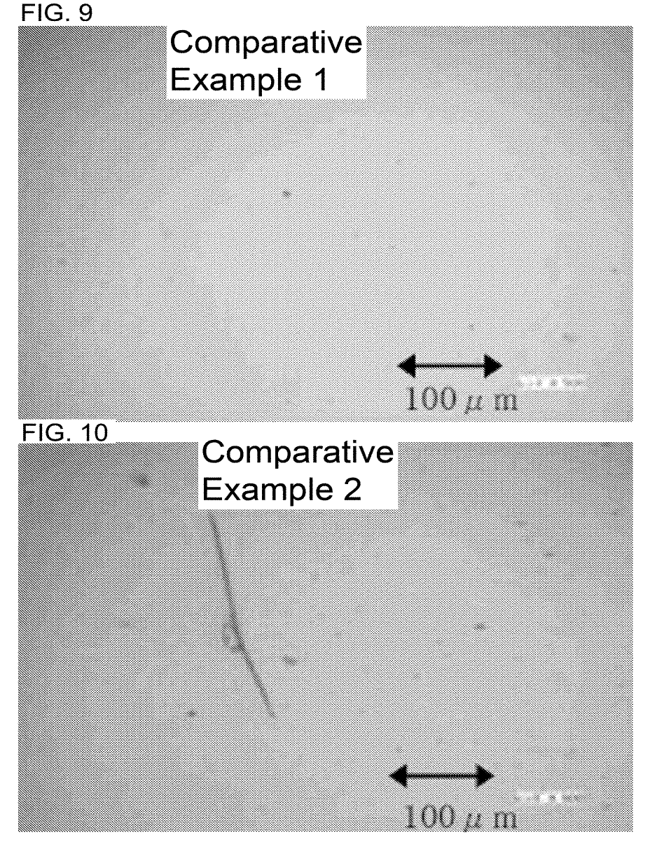

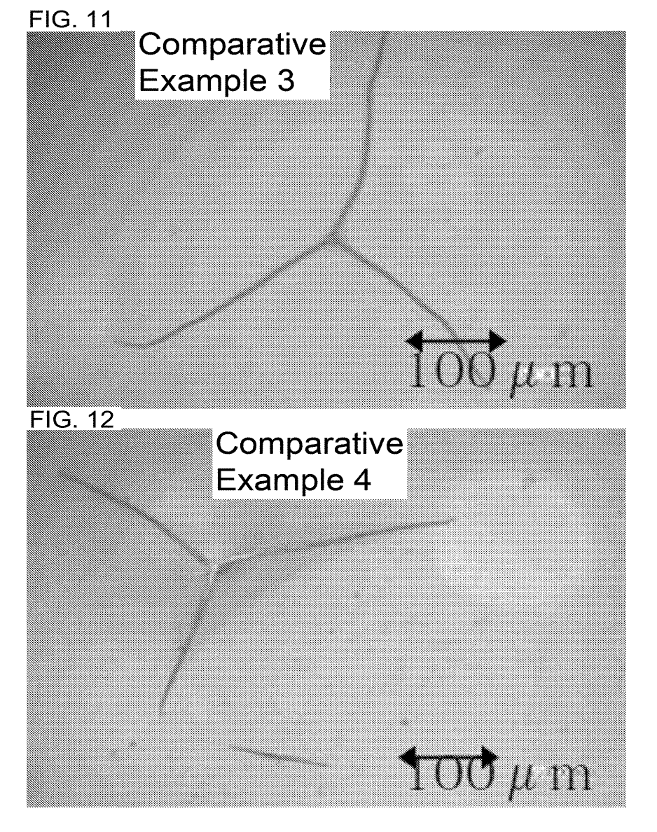

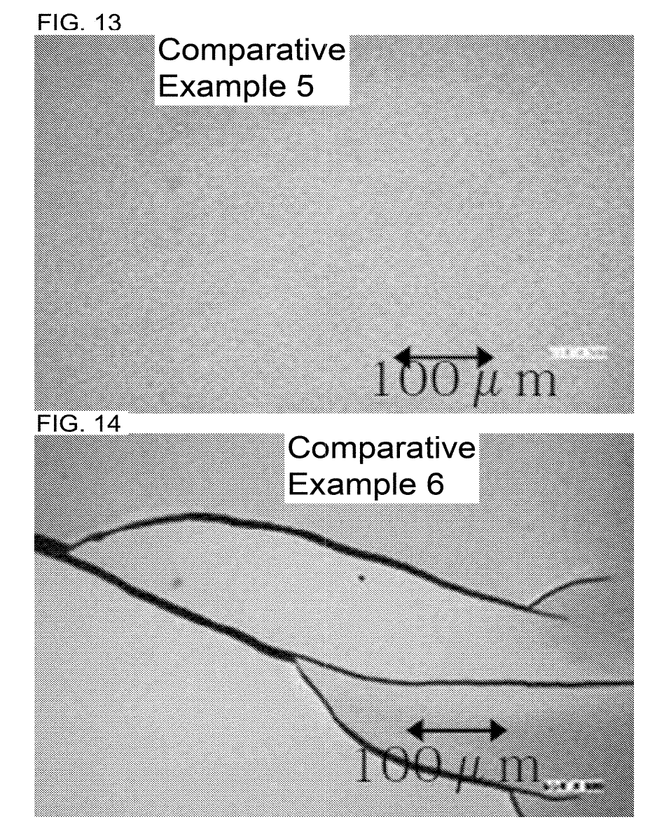

Using a Keyence VHX-500F digital microscope, film properties were observed in transmission mode and under 500× magnification, and evaluated by the criteria shown in Table 4. FIGS. 2-15 show images at 500× magnification. Regarding images in FIGS. 2˜15, wide black lines observed in FIGS. 9˜13 and a black line longer than 100 μm observed in FIG. 14 are cracks that occurred in the film.

TABLE 3

| | | | | | | Conversion | Film property |
|---|---|---|---|---|---|---|---|
| | | Type of | | Type of | | efficiency | of coated film |
| Slurry | | dispersion liquid | Amount | dispersion liquid | Amount | (%) | (15 μm) |
| Slurry 1 | Example 1 | dispersion liquid 1 | 100 | dispersion liquid 8 | 2 | 8.86 | 5 |
| Slurry 2 | Example 2 | dispersion liquid 1 | 100 | dispersion liquid 8 | 3.5 | 8.35 | 5 |
| Slurry 3 | Example 3 | dispersion liquid 1 | 100 | dispersion liquid 8 | 5.0 | 9.69 | 5 |
| Slurry 4 | Example 4 | dispersion liquid 1 | 100 | dispersion liquid 8 | 10 | 9.29 | 5 |
| Slurry 5 | Example 5 | dispersion liquid 1 | 100 | dispersion liquid 8 | 20 | 8.21 | 5 |
| Slurry 6 | Example 6 | dispersion liquid 2 | 100 | dispersion liquid 8 | 5 | 8.27 | 5 |
| Slurry 7 | Example 7 | dispersion liquid 3 | 100 | dispersion liquid 8 | 2 | 8.17 | 5 |
| Slurry 8 | Example 8 | dispersion liquid 9 | 100 | dispersion liquid 11 | 5.0 | 8.15 | 5 |
| Slurry 9 | Example 9 | dispersion liquid 10 | 100 | dispersion liquid 12 | 5.0 | 8.00 | 5 |
| Slurry 8′ | Comp. Example 1 | dispersion liquid 1 | 100 | — | — | 7.57 | 5 |
| Slurry 9′ | Comp. Example 2 | dispersion liquid 2 | 100 | — | — | 7.77 | 4 |
| Slurry 10 | Comp. Example 3 | dispersion liquid 3 | 100 | — | — | 7.61 | 3 |
| Slurry 11 | Comp. Example 4 | dispersion liquid 1 | 100 | dispersion liquid 8 | 25 | 6.97 | 3 |
| Slurry 12 | Comp. Example 5 | dispersion liquid 1 | 100 | dispersion liquid 4 | 5 | 7.42 | 3 |
| Slurry 13 | Comp. Example 6 | dispersion liquid 1 | 100 | dispersion liquid 5 | 5 | 6.23 | 2 |
| Slurry 14 | Comp. Example 7 | dispersion liquid 1 | 100 | dispersion liquid 7 | 5 | 8.26 | 3 |
| Slurry 15 | Comp. Example 8 | dispersion liquid 4 | 100 | dispersion liquid 5 | 5 | unable to | 0 |
| | | | | | | measure | |

TABLE 4
Film Property Evaluation Criteria (through microscope)

| | |
|---|---|
| 5 | No cracking |
| 4 | Origin of cracks observed at 2~3 spots in coated film (10 cm²) |
| 3 | Cracking observed spreading more than 4 in coated film (10 cm²) |
| 2 | Cracking observed further spreading in coated film (10 cm²) |
| 1 | Continuous cracking observed throughout coated film (10 cm²) |
| 0 | No adhesion |

### Examples 8˜16, Comparative Examples 9˜13

Electrode layers were each prepared the same as in Examples 1˜7 except that slurry 3 was used and the sintered film thicknesses were changed as shown in Table 5. Then, the same as in Examples 1˜7, electrode layers were each set on a cell to measure the conversion efficiency of each cell. The results are shown in Table 5.

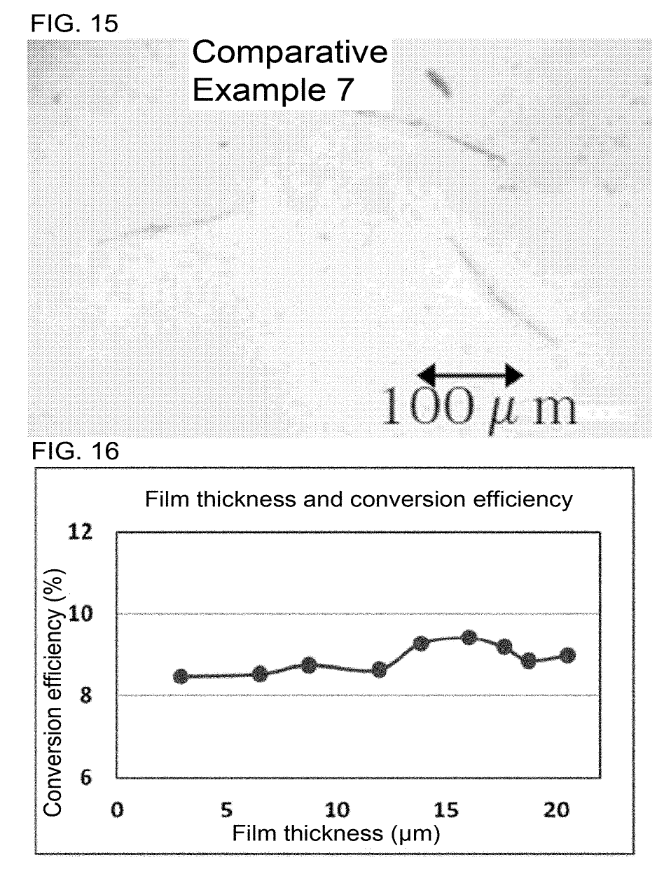

FIG. 16 shows a graph prepared from film thicknesses and conversion efficiencies in Examples 10˜18 shown in Table 5.

TABLE 5

| | | Film thickness | Conversion | |
|---|---|---|---|---|
| | | of electrode layer | efficiency | Film property |
| Slurry | | (μm) | (%) | of coated film |
| Slurry 3 | Example 10 | 2.9 | 8.47 | 5 |
| | Example 11 | 6.5 | 8.53 | 5 |
| | Example 12 | 8.7 | 8.74 | 5 |
| | Example 13 | 11.9 | 8.63 | 5 |
| | Example 14 | 13.8 | 9.26 | 5 |
| | Example 15 | 16.0 | 9.40 | 5 |
| | Example 16 | 17.6 | 9.17 | 5 |
| | Example 17 | 18.7 | 8.85 | 5 |
| | Example 18 | 20.5 | 8.96 | 5 |
| | Comp. | 22.5 | 8.44 | 4 |
| | Example 9 | | | |
| | Comp. | 23.1 | 8.64 | 4 |
| | Example 10 | | | |
| | Comp. | 1.9 | 5.60 | 2 |
| | Example 11 | | | |
| | Comp. | 26.2 | 6.73 | 4 |
| | Example 12 | | | |
| | Comp. | 28.1 | 6.43 | 3 |
| | Example 13 | | | |

As found in FIGS. 2˜15, cracks occurred in the films of Comparative Examples 2˜7, whereas no cracking was observed in electrode layers (porous photoelectrodes) prepared by using the slurry related to the present invention. Accordingly, it is found that electrode layers with virtually no cracks were achieved.

In addition, it is found that high conversion efficiency is achieved in each electrode layer (porous photoelectrode) prepared by using the slurry related to the present invention, whereas the conversion efficiency is insufficient in Comparative Example 1.

Furthermore, as shown in FIG. 16, it is found that electrode layers (porous photoelectrodes) prepared by using the slurry related to the present invention exhibit high conversion efficiencies of 8.0 or higher in a wide range of film thicknesses from less than 3 μm to 20 μm or thicker.

### INDUSTRIAL APPLICABILITY

According to the present invention, a dye-sensitized photoelectric conversion element is provided to exhibit high conversion efficiencies while showing virtually no cracks in a wide range of film thicknesses.

### DESCRIPTION OF NUMERICAL REFERENCES

1 solar cell
2 action electrode
3 counter electrode
4 sealing layer
5 sealed space
6 electrolyte
7 light-permissible substrate
8 transparent electrode member
9 dye-sensitized semiconductor layer, electrolyte layer
10 counter substrate
11 catalytic electrode layer
12 penetrating hole

1: A slurry, comprising:
a liquid medium; and
a plurality of metal-oxide semiconductor fine particles of different primary particle sizes that are dispersed in the liquid medium,
wherein the metal-oxide semiconductor fine particles include first fine particles having a modal primary particle size of 1˜50 nm and second fine particles having a modal primary particle size of 1˜13 nm such that the metal-oxide semiconductor fine particles in the liquid medium has a dispersed particle size of 1˜200 nm.

2: A slurry, comprising:
a polymer dispersant;
a liquid medium; and
a plurality of metal-oxide semiconductor fine particles of different primary particle sizes that are dispersed in the liquid medium;
wherein the metal-oxide semiconductor fine particles include first fine particles having a modal primary particle size of 1˜50 nm and second fine particles having a modal primary particle size of 1˜13 nm.

3: The slurry of claim 2, wherein the polymer dispersant is at least one type selected from the group consisting of an acrylic copolymer, a butyral resin, a vinyl acetate copolymer, a hydroxyl group-containing carboxylic acid ester, a salt of a high molecular weight polycarboxylic acid, an alkyl polyamine, and a polyhydric alcohol ester.

4: The slurryr of claim 1, wherein the metal-oxide semiconductor fine particles comprise at least one type selected from the group consisting of a titanium oxide, a tin oxide, a niobium oxide, a tungsten oxide, and strontium titanate.

5: The slurry of claim 1, wherein the first fine particles and the second fine particles are present at a weight ratio of 100/1˜23.

6: A method for forming a semiconductor electrode layer, comprising:
coating a substrate with the slurry of claim 1; and
sintering a coated slurry.

7: A semiconductor electrode layer, obtained by a process including coating a substrate with the slurry of claim 1 and sintering a coated slurry.

8: The semiconductor electrode layer of claim 7, wherein the metal-oxide semiconductor fine particles comprise at least one type selected from the group consisting of a titanium oxide, a tin oxide, a niobium oxide, a tungsten oxide, and strontium titanate.

9: The semiconductor electrode layer of claim 7, wherein the first fine particles and the second fine particles are present in the slurry at a weight ratio of 100/1˜23.

10: A semiconductor electrode layer, comprising:
a plurality of metal-oxide semiconductor fine particles having different primary particle sizes,
wherein the semiconductor electrode layer has a thickness of 3 μm˜20 μm with substantially no cracking and has conversion efficiency of 8.0 or higher.

11: A solar cell, comprising:
an electrode comprising the semiconductor electrode layer of claim 7.

12: A solar cell, comprising:
an electrode comprising the semiconductor electrode layer of claim 10.

13: The semiconductor electrode layer of claim 8, wherein the first fine particles and the second fine particles are present in the slurry at a weight ratio of 100/1˜23.

14: The slurry of claim 2, wherein the metal-oxide semiconductor fine particles comprise at least one type selected from the group consisting of a titanium oxide, a tin oxide, a niobium oxide, a tungsten oxide, and strontium titanate.

15: The slurry of claim 3, wherein the metal-oxide semiconductor fine particles comprise at least one type selected from the group consisting of a titanium oxide, a tin oxide, a niobium oxide, a tungsten oxide, and strontium titanate.

16: The slurry of claim 2, wherein the first fine particles and the second fine particles are present at a weight ratio of 100/1˜23.

17: The slurry of claim 3, wherein the first fine particles and the second fine particles are present at a weight ratio of 100/1˜23.

18: The slurry of claim 4, wherein the first fine particles and the second fine particles are present at a weight ratio of 100/1˜23.

19: A method for forming a semiconductor electrode layer, comprising:
coating a substrate with the slurry of claim 2; and
sintering a coated slurry.

20: The method of claim 19, wherein the metal-oxide semiconductor fine particles comprise at least one type selected from the group consisting of a titanium oxide, a tin oxide, a niobium oxide, a tungsten oxide, and strontium titanate.
